(19) United States
(12) Patent Application Publication
(10) Pub. No.: US 2019/0003696 A1
(43) Pub. Date: Jan. 3, 2019

(54) LIGHTING EQUIPMENT

(71) Applicant: Mitsubishi Chemical Corporation, Chiyoda-ku (JP)

(72) Inventor: Toshihiko KURIYAMA, Kanagawa (JP)

(73) Assignee: Mitsubishi Chemical Corporation, Chiyoda-ku (JP)

(21) Appl. No.: 16/058,327

(22) Filed: Aug. 8, 2018

Related U.S. Application Data
(63) Continuation of application No. PCT/JP2017/004455, filed on Feb. 7, 2017.

(30) Foreign Application Priority Data
Feb. 9, 2016 (JP) 2016-022778

(51) Int. Cl. F21V 29/503; F21V 7/06; F21V 29/76; F21V 29/89; F21V 29/85; F21V 29/80

(52) U.S. Cl. CPC F21V 29/503; F21V 7/06; F21V 29/763; F21Y 2115/10; F21V 29/86; F21V 29/80; F21V 29/89

(57) ABSTRACT

A lighting equipment comprises: an LED light emitting device; a heat sink connected to the LED light emitting device; and a light collecting member configured to control a light distribution of the LED light emitting device to a range that is narrower than that of the light distribution of the LED light emitting device, wherein the heat sink comprises: a bottom plate; and a plurality of pillar-shaped or flat plate-shaped heat conductive members connected to the bottom plate at one of ends thereof, the LED light emitting device is located at a central area of the bottom plate, and when assuming a maximum thickness of the central area of the bottom plate is tc, and a minimum thickness of an outer circumferential area of the bottom plate is te, tc/te≥1.2 is satisfied.

### TECHNICAL FIELD

The present invention relates to a lighting equipment that includes an LED light emitting device.

### BACKGROUND ART

Various lighting equipments have been developed which use a semiconductor light emitting device such as a light emitting diode (LED) that is highly efficient and has a long service life in place of a general lamp such as a tungsten halogen lamp. When an LED is heated to a high temperature by heat generated from the LED, there is caused a problem in that the light emitting efficiency is reduced to thereby reduce an output of light from a lighting equipment and a problem in that the service life of the LED is shortened. To cope with these problems, in lighting equipments of this type, there is known a light emitting system including a heat sink configured to dissipate heat generated from an LED (Refer to Patent Documents 1 to 3).

### CITATION LIST

### Patent Documents

Patent Document 1: WO 2014/119169 A1

Patent Document 2: JP-A-2014-67728

Patent Document 3: Japanese Patent Publication No. 5276239

### SUMMARY OF THE INVENTION

### Technical Problems

To dissipate heat generated from an LED, various types of heat sinks are used in an attempt to dissipate the heat efficiently. However, since heat sinks are normally made of metal such as aluminum to thereby increase the weight and size of an LED lighting equipment, there are fears that the safety and easy handling properties of the LED lighting equipment are lost. On the other hand, in a case where a light resin heat sink is used, heat cannot be dissipated sufficiently, whereby the light emitting efficiency is reduced, leading to a problem in that light of a sufficient luminous flux cannot be emitted from the LED lighting equipment or in that the service lives of peripheral circuits of a semiconductor light emitting device and a condenser are shortened.

In addition, in an LED lighting equipment having a luminous intensity distribution given the directivity of a spot light, a lens and a reflector are used to collect light, whereby light is lost largely, causing a problem in that the light emitting efficiency from the lens is reduced or in that unevenness in brightness or color is generated on a surface where light is irradiated due to LEDs being disposed to be dispersed.

In Patent Documents 1 to 3, a lighting equipment using an LED light emitting device is provided. This lighting equipment is light in weight and small in size and has a good heat dissipating performance thereby not only to emit light of a great luminous flux but also to have a long service life. Further, the light emitting system has superior directivity and luminous intensity distribution properties, as well as a high heat dissipating performance, whereby LEDs can be disposed in a concentrated fashion. Thus, the LED lighting equipment becomes free from unevenness in brightness and color.

With a narrow-angled light distribution lens in Patent Document 1 and the like, since the lens has a convex surface on an incident side in an optical axis direction, light is lost largely, whereby the light emitting efficiency from the lens is reduced or unevenness in brightness or color is generated on a surface where light from the lens is irradiated. In addition, in Patent Document 2 and the like, light attempting to return towards a light source is generated due to dispersion of light, causing a problem in that illumination efficiency is reduced or in that sufficient narrow-angled light distribution properties are not obtained. Further, since a dispersing treatment is applied partially, it becomes difficult to work on the lens accordingly, causing a problem in that the production cost is increased to a high level. Additionally, there is caused a problem in that the light collecting efficiency of the lens is low, leading to the fact that the effect of improving the unevenness in color is low.

The invention has been made in view of these problems, and an object of the invention is to provide a small and light spot lighting equipment of a great luminous flux that can collect light at a narrow angle, lose less light and generate little unevenness on a surface where light is irradiated, when using an LED light emitting device as its light source.

### Means for Solving the Problems

To solve the problems, the gist of the invention is as follows.

[1] A lighting equipment comprising:

an LED light emitting device;

a heat sink connected to the LED light emitting device; and

a light collecting member configured to control a light distribution of the LED light emitting device to a range that is narrower than that of the light distribution of the LED light emitting device,

wherein the heat sink comprises:

a bottom plate; and

a plurality of pillar-shaped or flat plate-shaped heat conductive members connected to the bottom plate at one of ends thereof,

wherein the LED light emitting device is located at a central area of the bottom plate, and

wherein when assuming a maximum thickness of the central area of the bottom plate is tc, and a minimum thickness of an outer circumferential area of the bottom plate is te, tc/te≥1.2 is satisfied.

[2] The lighting equipment according to [1],

wherein a surface of the bottom plate to which the heat conductive members are connected is a flat surface or a convex surface.

[3] The lighting equipment according to [1] or [2],

wherein a total sum of inclinations of minute sections from an outer circumferential edge portion towards a central portion on an LED light emitting device located surface and/or an opposite surface to the LED light emitting device located surface in a cross section of the bottom plate, is positive.

[4] The lighting equipment according to any one of [1] to [3],

wherein a void space existing in an interior of the bottom plate is 30% or smaller.

[5] The lighting equipment according to any one of [1] to [4],

wherein when assuming that a maximum height of the pillar-shaped or flat plate-shaped heat conductive members from the LED light emitting device located surface of the bottom plate is hp, hp/tc≥1.2 is satisfied.

[6] The lighting equipment according to any one of [1] to [5],

wherein the plurality of pillar-shaped or flat plate-shaped heat conductive members have a substantially cylindrical external appearance.

[7] The lighting equipment according to any one of [1] to [6],

wherein a maximum temperature area resulting from a heat generation of the LED light emitting device exists within a central area of the bottom plate.

[8] The lighting equipment according to any one of [1] to [7],

wherein a heat conductivity of the heat sink ranges from 20 W/(m·k) to 400 W/(m·k).

[9] The lighting equipment according to any one of [1] to [8],

wherein a material of the heat sink is a metal, or boron nitride.

[10] The lighting equipment according to any one of [1] to [9], wherein when assuming that a diagonal maximum length of the LED light emitting device is L_{E}, and a diagonal maximum length of the bottom plate is L_{B}, L_{E}/L_{B} is 0.7 or smaller.
[11] The lighting equipment according to any one of [1] to [10],

wherein the diagonal maximum length L_{B} of the bottom plate is 40 mm or greater.

[12] The lighting equipment according to any one of [1] to [11],

wherein a shape of a cross section of the bottom plate including a central portion thereof is any one selected from a group of shapes including a pentagonal shape, a polygonal shape and a convex curve.

[13] The lighting equipment according to any one of [1] to [12],

wherein the LED light emitting device is a COB type light emitting device.

[14] The lighting equipment according to any one of [1] to [13],

wherein the light collecting member is a reflector or a lens.

[15] The lighting equipment according to [14],

wherein the reflector has a shape of parabolic rotating body.

[16] The lighting equipment according to [15],

wherein the LED light emitting device is located in a focal position of the reflector having a shape of parabolic rotating body.

[17] The lighting equipment according to [15] or [16],

wherein when assuming that a maximum diameter of a light emitting portion of the LED light emitting device is W, a light emitting center of the LED light emitting device exists within a range of a spherical body whose radius is 5 W from the focal position of the reflector having a shape of parabolic rotating body.

### Advantageous Effect of the Invention

According to the invention, it is possible to provide the small and light spot lighting equipment of a great luminous flux that can collect light at a narrow angle, lose less light and generate little unevenness on a surface where light is irradiated, when using an LED light emitting device as its light source. Namely, in relation to a chart showing a relation between beam angle and luminous intensity, light emitted from the lighting equipment exhibits a moderate sloping shape with no shoulder or the like at a base of a peak. In particular, when using a one-core type light source having an output that is great to some extent, as a luminescent source that is represented by a lighting equipment or the like that uses an LED light emitting device of a chip on board (COB) type, the advantageous effect can be obtained.

### BRIEF DESCRIPTION OF DRAWINGS

FIG. 1A and FIG. 1B show perspective views of a lighting equipment according to an embodiment of the invention, in which FIG. 1A is a perspective view when the lighting equipment is seen from front (an irradiating direction), and FIG. 1B is a perspective view when the lighting equipment is seen from rear (a non-irradiating direction).

FIG. 2 is a side sectional view of the lighting equipment (a lamp portion) according to the embodiment of the invention.

FIG. 3A and FIG. 3B show a heat sink used in the lighting equipment according to the embodiment of the invention, in which FIG. 3A is a side view of the heat sink, and FIG. 3B is a perspective view of the heat sink.

FIG. 4A and FIG. 4B show a heat sink (of a pin type) used in the lighting equipment according to the embodiment of the invention, in which FIG. 4A is a sectional view of the heat sink, and FIG. 4B is a perspective of the heat sink.

FIG. 5 is a chart illustrating a relation between increments of a thickness of and temperatures at a central portion of a heat sink bottom plate in the lighting equipment according to the embodiment of the invention.

FIG. 6 is a chart illustrating a relation between increments of a thickness of and temperatures at an outer circumferential portion of the heat sink bottom plate in the lighting equipment according to the embodiment of the invention.

### MODE FOR CARRYING OUT THE INVENTION

Hereinafter, referring to drawings, a mode for carrying out the invention will be described on the basis of an example and a modified example. It should be noted that the invention is not limited to what will be described below but can be carried out while being modified arbitrarily without departing from a sprit and scope of the invention. Additionally, drawings used in description of the example and the modified example each illustrate schematically a lighting equipment according to the invention, and the drawings are partially exaggerated, enlarged, contracted or omitted and hence do not always represent a scale or a shape of each of constituent members accurately. Further, various numeric values and amounts used in the examples and each modified example indicate examples and hence can be modified variously as required.

(Lighting Equipment)

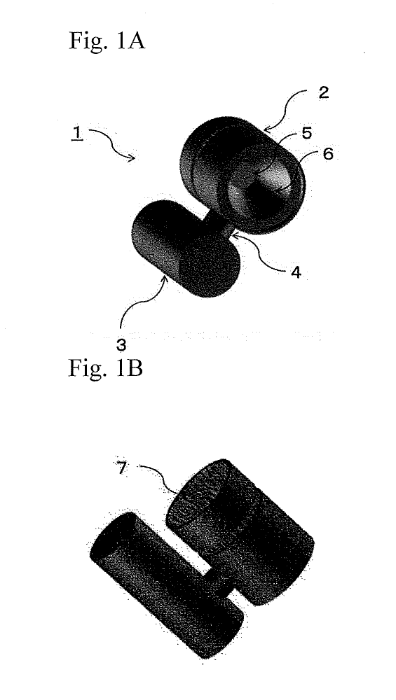

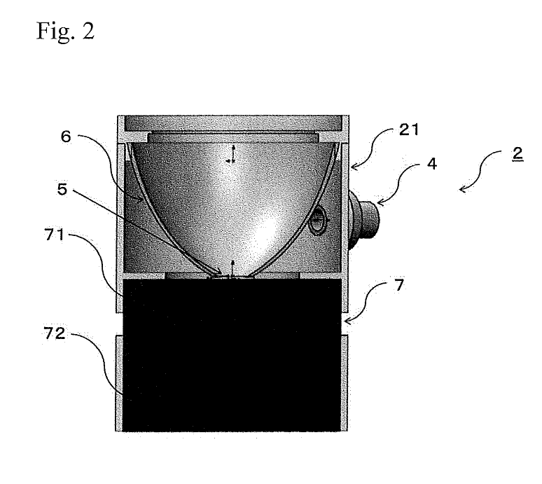

A lighting equipment according to the embodiment is an LED lighting equipment including an LED light emitting device as a light source. Here, firstly, referring to FIGS. 1 and 2, an example will be described in which a lighting equipment 1 according to the embodiment, which is referred to as an LED track lighting having an outside diameter of about 70 mm, makes up a lighting equipment 1.

FIG. 1 shows perspective views of an LED track light lighting equipment 1 according to the embodiment, and FIG. 2 is a side sectional view of a lamp 2 portion of the LED track light lighting equipment 1 according to the embodiment. The LED track light lighting equipment 1 has an LED light emitting device 5, a heat sink 7, a light collecting member (a reflector) 6, a lamp casing 21 and the like. A lamp 2 having the LED light emitting device 5, the heat sink 7, the light collecting member (the reflector) 6, the lamp casing 21 and the like is connected to a power supply case 3 by an arm portion 4. A connecting angle at which the lamp 2 and the power supply case 3 are connected together can be adjusted by the arm portion 4.

In this description, a side of the lighting equipment 1 (the LED track light lighting equipment 1) where the reflector 6 is provided is defined as “front.”

The LED light emitting device 5 is a one-core type COB light emitting device and is disposed at a central portion of a heat sink bottom plate 71 as a light source. Disposing the LED light emitting device 5 in this way can not only make light emitted from the LED light emitting device 5 as light of high directivity (a narrow light distribution angle) but also dissipate heat generated in the LED light emitting device 5 from the lighting equipment. The heat sink 7 includes the bottom plate 71 and a plurality of pillar-shaped heat conductive members 72 that are connected to the bottom plate at one of ends thereof.

A maximum thickness tc of a central area of the bottom plate 71 is greater than a minimum thickness te of an outer circumferential area of the bottom plate 71, whereby heat generated in the LED light emitting device 5 that is disposed at the central area of the heat sink bottom plate 71 is conducted efficiently to the outer circumferential area of the heat sink bottom plate 71, from where the heat is conducted through the plurality of pillar-shaped heat conductive members 72 and is then dissipated efficiently from respective surfaces of the heat conductive members 72.

Light emitted from the COB LED light emitting device 5 is reflected and collected by the reflector 6 and is then emitted to the front of the lighting equipment as light of high directivity (a narrow light distribution angle). The LED light emitting device 5 is located in a position lying near a focal point of the reflector 6 that is formed substantially into the shape of parabolic rotating body, whereby light can be collected efficiently without unevenness of light.

The lighting equipment of the invention applied for patent by this patent application can be formed small in size and light in weight while maintaining the required light collecting performance and luminous flux, and a value of luminous flux of light emitted per mass of the lighting equipment (the lamp portion) is normally 3.5 lumen/g or greater, preferably, 4.0 lumen/g or greater, and more preferably, 5.0 lumen/g or greater. Additionally, a ½ beam angle of light emitted from the lighting equipment (the lamp portion) preferably ranges from 50 to 50°, more preferably to 40°, much more preferably to 25°, and most preferably to 15°.

The lighting equipment of the invention applied for patent by this patent application can be formed small in size and light in weight while maintaining the required light collecting performance and luminous flux, and therefore, the lighting equipment can preferably be applied to a spot light.

(LED Light Emitting Device)

It is preferable that the LED light emitting device 5 uses a single one-core (one integrated light source) type module, which is a single light source where LED chips are collected to be disposed at a central portion of a module substrate and which emits light only from one light emitting surface. The LED lighting equipment can constitute a point light source as a whole by adopting this one-core type LED light source (a semiconductor light emitting device). Additionally, multiple shadows can effectively be eliminated or mitigated by adopting this one-core type LED light source, thereby making it possible to realize an illumination effect that is little uneven or even and stable in luminous intensity. A COB structure is preferably used as a one-core type module, and in this COB structure, one or a plurality of LED chips are mounted directly on wiring provided on a mounting surface of a module substrate.

A metal based substrate that is formed, for example, of a metallic material such as aluminum having good heat conductivity or an insulating material is used preferably as a module substrate on which LED chips are mounted.

The COB type LED light emitting device 5 has a COB structure in which one or a plurality of blue LED chips are mounted directly on wiring provided on a mounting surface of a module substrate and are potted with a transparent or light transmitting resin in which a green luminescent material and a red luminescent material are mixed together which emit lights of colors corresponding thereto when excited by blue light emitted from the blue LED chips. Not only blue LED chips but also various types of LED chips such as near ultraviolet LED chips or the like can be used as LED chips, and various types of luminescent materials can be selected depending upon LED chips used. In this embodiment, LED chips having a sapphire substrate can be used as LED chips. However, LED chips having a GaN (gallium nitride) substrate can also be used. In this way, in a case where LED chips having a GaN substrate are adopted, a great current can be introduced, thereby making it possible to realize a point light source having great luminous flux.

The LED light emitting device 5 can adopt a packaged structure in place of the COB structure and then can be applied to various forms. Additionally, in the LED light emitting device 5, a plurality of semiconductor light emitting devices can also be disposed so as to spread over a module substrate. A characteristic close to that of the COB type LED light emitting device can be provided by disposing small packaged LED light emitting devices 5 so as to lie close to one another.

In addition, other substrates than the sapphire substrate such as the GaN substrate, a silicone substrate and the like may also be used for LED chips.

(Heat Sink)

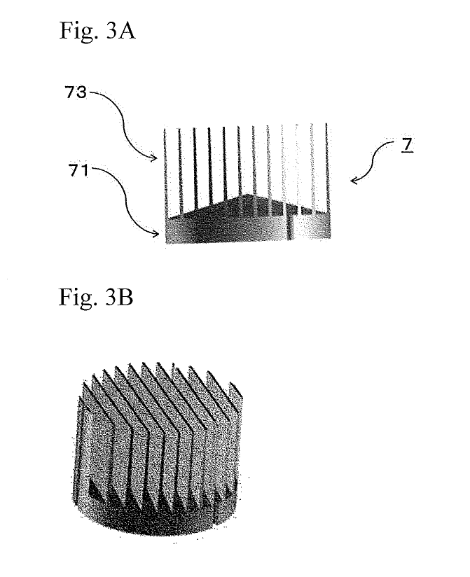

FIG. 3 shows a heat sink (of a fin type) that is used in the lighting equipment according to the embodiment of the invention, in which FIG. 3A is a side view and FIG. 3B is a perspective view of the heat sink.

A heat sink 7 includes a bottom plate 71 and a plurality of flat plate-shaped heat conductive members 73 that are connected to the bottom plate 71 at one of ends thereof. The LED light emitting device is designed to be located in a central area of a surface of an opposite side of the bottom plate 71 to a side to which the heat conductive members are connected. Here, the central area is an area like a central portion of a circle that includes the central area of the surface on which the LED light emitting device is located. Specifically, the central area is an area situated directly above the area where the LED light emitting device is located and constitutes an area having a superior heat conductivity of heat generated in the LED light emitting device to an outer circumferential area of the bottom plate 71. Additionally, in collecting light emitted from the LED light emitting device by the light collecting member, the central area is an area where light from the LED light emitting device can be collected without any loss of the light and unevenness of light thereon. For example, depending upon a desired ½ bean angle, in general, in the case where the bottom plate 71 is circular, the central area means a range that spreads from a central point of the circle to a point situated within a half of a diameter of the circle.

Assuming that a maximum thickness of the central area of the bottom plate 71 of the heat sink 7 is tc, and a minimum thickness of the circumferential area of the bottom plate 71 is te, tc/te≥1.2, and preferably, tc/te≥1.5, is satisfied. Here, the outer circumferential area means a portion of the bottom plate 71 excluding the central area and an area where the LED light emitting device is not located. This allows heat generated in the LED light emitting device located at the central area of the heat sink bottom plate 71 to be conducted to the outer circumferential area of the heat sink bottom plate 71 efficiently. Then, the heat conducted is conducted from the outer circumferential area through the plurality of flat plate-shaped or pillar-shaped heat conductive members to be dissipated efficiently from the respective surfaces of the heat conductive members.

The thicknesses of the central area and the outer circumferential area may remain constant over a certain area or change continuously. Additionally, the thicknesses may change continuously so that a distance from a central point of the bottom plate to an end portion of the bottom plate becomes constant. As this occurs, the surface of the bottom plate to which the heat conductive members are connected (hereinafter, referred to as a connecting surface from time to time) is preferably flat or convex and is more preferably convex. A sufficient length can be ensured for the heat conductive members on the outer circumferential area as a result of the connecting surface being flat or convex, thereby making is possible to enhance the heat dissipating efficiency further.

For example, in relation to a sectional shape of the bottom plate, in the case where the connecting surface has a substantially semi-spherical shape, heat is conducted uniformly at the bottom plate, and a sufficient length can be ensured for the heat conductive members on the outer circumferential area. Thus, it is assumed that the heat dissipating efficiency is increased to a particularly high level.

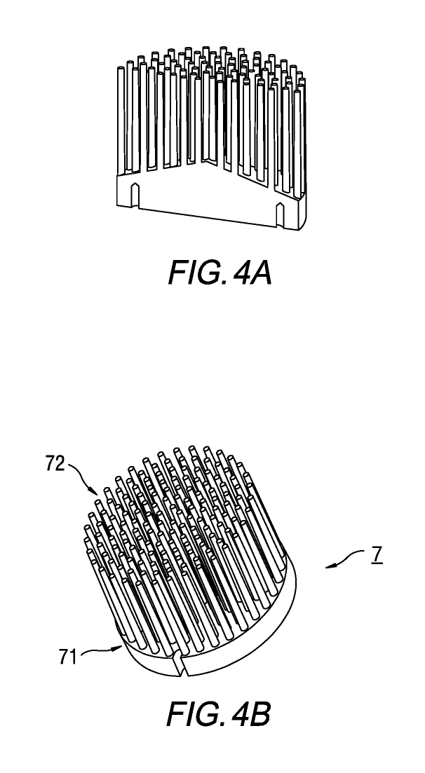

FIG. 4 shows a heat sink (of a pin type) used in the lighting equipment according to the embodiment of the invention, in which FIG. 4A is a sectional view and FIG. 4B is a perspective view of the heat sink. A heat sink 7 includes a bottom plate 71 and a plurality of pillar-shaped heat conductive members 72 connected to the bottom plate 71 at one of ends thereof.

It is preferable that a total sum of inclinations at minute sections from an outer edge portion towards a central portion on an LED light emitting device located surface and/or an opposite surface to the LED light emitting device located surface in a cross section of the bottom plate 71 is positive. By adopting this configuration, heat at a central area of the bottom plate 71 can be conducted to the heat conductive members 72 efficiently through an outer circumferential area, thereby making it possible to enhance the heat dissipating efficiency.

A void space existing in an interior of the heat sink bottom plate 71 is preferably 30% or smaller, more preferably 20% or smaller, and much more preferably 10% or smaller. Most preferably, the interior of the heat sink bottom plate 71 has a completely solid structure. This enables heat at the central area of the bottom plate 71 to be conducted efficiently to the heat conductive members 72 through the outer circumferential area, thereby making it possible to enhance the heat dissipating efficiency.

Assuming that a maximum height of the pillar-shaped or flat plate-shaped heat conductive members from the LED light emitting device located surface of the bottom plate 71 is hp, it is preferable that hp/tc≥1.2 is satisfied, from a heat dissipating point of view. It is more preferable that hp/tc≥1.5 is satisfied. It is much more preferable that hp/tc≥2.0 is satisfied. When hp/tc is equal to or greater than a lower limit value, a difference in heat conductivity to the heat conductive members between the central area and the outer circumferential area becomes small, and this is preferable from the viewpoint that the heat dissipation of the heat conductive members on the outer circumferential area is enhanced more.

In addition, it is preferable from the heat dissipating point of view that the pillar-shaped or flat plate-shaped heat conductive members each have a substantially cylindrical external appearance. Although the flat plate-shaped heat conductive members 73 may be disposed in any direction, from a viewpoint of heat dissipating efficiency, the flat plate-shaped heat conductive members may be disposed in a direction in which the flat plates become parallel to one another or may be disposed in a radial direction.

It is preferable from the heat dissipating point of view that a maximum temperature area where the temperature becomes maximum due to a heat generation of the LED light emitting device exists within the central area of the heat sink bottom plate.

Additionally, the heat conductivity of the heat sink is 400 W/(m·k) or smaller from the heat dissipating point of view, and the heat conductivity of the heat sink is preferably 20 W/(m·k) or greater and is more preferably 50 W/(m·k).

It is preferable from the heat dissipating point of view that a material for the heat sink is a metal, or boron nitride. Additionally, as metal, aluminum, copper or an alloy of aluminum and copper is preferable.

Assuming that a diagonal maximum length of the LED light emitting device is L_{E}, and a diagonal maximum length of the bottom plate is L_{B}, it is preferable from the heat dissipating point of view that L_{E}/L_{B} is 0.7 or smaller.

Additionally, it is preferable from the heat dissipating point of view that the diagonal maximum length L_{B} of the bottom plate is 40 mm or greater.

There is imposed no specific limitation on the shape of a cross section including the central portion of the bottom plate. However, it is preferable from the heat dissipating point of view that the shape of the cross section is any one selected from a group of shapes including a pentagonal shape, a polygonal shape and a convex curve.

(Light Collecting Member)

The light collecting member used in this invention is a member configured to control a luminous intensity or light distribution of the LED light emitting device to a range that is narrower than that of the light distribution of the LED light emitting device. For example, in the case where a ½ beam angle of light emitted from the LED light emitting device ranges from 120° to 150°, the LED light emitting device can be configured as a lighting equipment that emits light whose ½ beam angle ranges from 5° to 60° by using the light collecting member. Specifically speaking, a reflector or a lens is preferably used as the light collecting member.

It is preferable that the reflector is formed substantially into the shape of parabolic rotating body. Then, it is preferable from a light collecting point of view that the LED light emitting device is located in a focal point position of the substantially paraboloidal reflector.

In addition, when assuming that a maximum diameter of a light emitting portion of the LED light emitting device is W, it is preferable from the light collecting point of view that a light emitting center of the LED light emitting device is positioned within a range of a spherical body whose radius is 5 W and is more preferable that the light emitting center is positioned within a range of a spherical body whose radius is 3 W from the focal position of the substantially paraboloidal reflector.

It is preferable that the lens is located so as to be positioned in front of the LED light emitting device. The lens is normally formed into the shape of parabolic rotating body that is centered at an optical axis of the lens and has a structure is made up of an incident plane or a light entrance plane, a light exit plane and a side reflecting plane. Additionally, it is preferable that a one-core type lens is used. When referred to herein, the one-core type lens is a lens having only one optical axis and giving a predetermined light distribution angle to light emitted from the lens.

(Lamp Casing)

The lamp casing 21 accommodates the LED light emitting device 5, the heat sink 7, the reflector 6 and the like and functions to protect them.

The lamp casing 21 can take a form in which the lamp casing 21 is connected to the power supply case 3 via the arm portion 4 provided to a side of the lamp casing 21. This facilitates setting the lighting equipment on a ceiling or the like and enables a irradiating direction of light from the lamp to be adjusted in a flexible fashion.

(Power Supply Case)

The power supply case 3 accommodates a power supply and is connected to the lamp casing 21 via the arm portion 4. The power supply case 3 is normally configured to be fixed to the ceiling or the like.

### Reference Examples

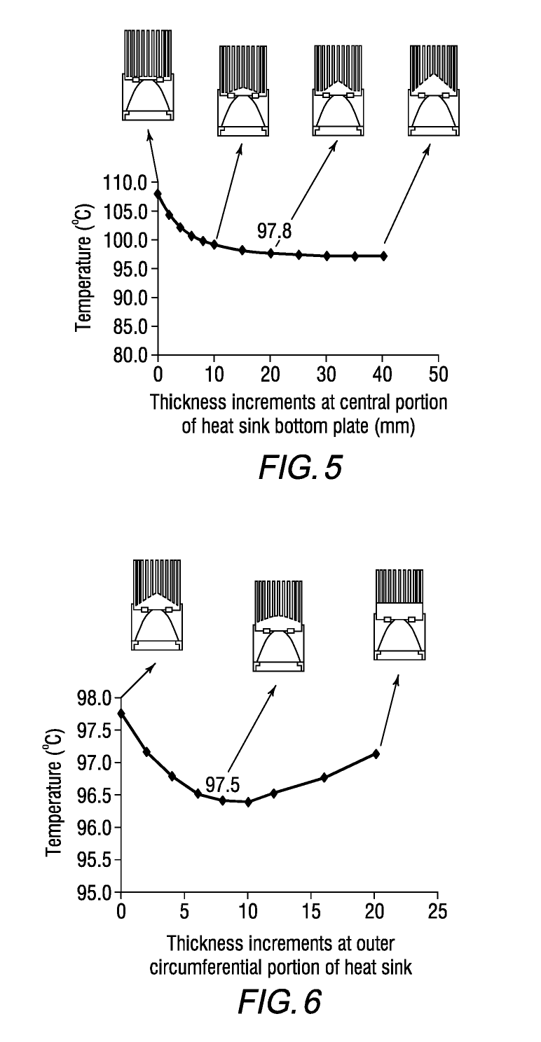

FIG. 5 and Table 1 show a relation between thickness increments at the central portion of the heat sink bottom plate of the lighting equipment according to the embodiment of the invention and temperatures at the located surface of the COB type LED light emitting device of the heat sink. The results shown in Table 1 were calculated by using the Solidworks Flow Simulation. With the heat value of an LED light emitting device set at 36 W, a model was prepared in which the LED light emitting device was located on a heat sink via a heat dissipating sheet (its heat conductivity: 1 W/m·k). The heat sink had a diameter of 63 mm and a height of 67 mm, and 99 cylindrical heat conductive members having a diameter of 3 mm were provided on a bottom plate of the heat sink. The heat sink had a heat conductivity of 92 W/m·k, and a maximum temperature on an LED light emitting device located surface of the heat sink was evaluated at a point in time when temperatures of the constituent members reached an equilibrium state after the LED light emitting device had been heated by heat generated by the LED light emitting device itself.

TABLE 1

| Thickness increments | |
|---|---|
| at central portion of | |
| bottom plate of heat | Temperature |
| sink (mm) | (° C.) |
| 0 | 108.0 |
| 2 | 104.3 |
| 4 | 102.1 |
| 6 | 100.8 |
| 8 | 99.8 |
| 10 | 99.1 |
| 15 | 98.2 |
| 20 | 97.8 |
| 25 | 97.4 |
| 30 | 97.3 |
| 35 | 97.2 |
| 40 | 97.3 |

When the thickness of the central portion of the heat sink bottom plate is increased from 3 mm, although the temperature tends to decrease greatly from an increment of 0 to an increment of 15 mm or the like, the temperature tends not to change so greatly from an increment of 20 mm and up.

Additionally, when the thickness of the central portion of the heat sink bottom plate is increased by 20 mm, the temperature at the LED light emitting device located surface decreases from 108° C. to 98° C., and this shows an improvement of about 10° C. in temperature.

FIG. 6 and Table 2 show a relation between thickness increments at the outer circumferential portion of the heat sink bottom plate of the lighting equipment according to the embodiment of the invention and temperatures at the located surface of the LED light emitting device of the heat sink.

TABLE 2

| Thickness increments at outer | |
|---|---|
| circumferential portion of | Temperature |
| bottom plate of heat sink (mm) | (° C.) |
| 0 | 97.8 |
| 2 | 97.2 |
| 4 | 96.8 |
| 6 | 96.5 |
| 8 | 96.4 |
| 10 | 96.4 |
| 12 | 96.5 |
| 16 | 96.8 |
| 20 | 97.1 |

The thickness of the central portion of the heat sink bottom plate was 20 mm to be optimized relative to the thickness of the outer circumferential portion. As a result, in relation to the thickness of the outer circumferential portion, an optimal point is found at around an increment of 8 mm to an increment of 10 mm.

With the thickness of the central portion of the heat sink bottom plate set at 20 mm, by increasing the thickness of the outer circumferential portion by 8 mm, the temperature at the located surface of the LED light emitting device decreases from 108° C. to 96° C. Thus, an improvement of about 12° C. is provided.

While the invention has been described in detail or by reference to the specific embodiment, it is obvious to those skilled in the art to which the invention pertains that various alterations or modifications can be made to the embodiment described. This patent application is based on Japanese Patent Application No. 2016-022778 field on Feb. 9, 2016, the contents of which are incorporated herein by reference.

### DESCRIPTION OF REFERENCE NUMERALS

1 Lighting equipment; 2 Lamp; 21 Lamp Casing; 3 Power Supply Case; 4 Arm Portion; 5 LED Light Emitting Device; 6 Reflector; 7 Heat Sink; 71 Bottom Plate; 72 Heat Conductive Member (Pillar-shaped); 73 Heat Conductive Member (Flat plate-shaped).

1. A lighting equipment comprising:
an LED light emitting device;
a heat sink connected to the LED light emitting device; and
a light collecting member configured to control a light distribution of the LED light emitting device to a range that is narrower than that of the light distribution of the LED light emitting device,
wherein the heat sink comprises:
a bottom plate; and
a plurality of pillar-shaped or flat plate-shaped heat conductive members connected to the bottom plate at one of ends thereof,
wherein the LED light emitting device is located at a central area of the bottom plate, and
wherein when assuming a maximum thickness of the central area of the bottom plate is tc, and a minimum thickness of an outer circumferential area of the bottom plate is te, tc/te≥1.2 is satisfied.

2. The lighting equipment according to claim 1,
wherein a surface of the bottom plate to which the heat conductive members are connected is a flat surface or a convex surface.

3. The lighting equipment according to claim 1,
wherein a total sum of inclinations of minute sections from an outer circumferential edge portion towards a central portion on an LED light emitting device located surface and/or an opposite surface to the LED light emitting device located surface in a cross section of the bottom plate, is positive.

4. The lighting equipment according to claim 1,
wherein a void space existing in an interior of the bottom plate is 30% or smaller.

5. The lighting equipment according to claim 1,
wherein when assuming that a maximum height of the pillar-shaped or flat plate-shaped heat conductive members from the LED light emitting device located surface of the bottom plate is hp, hp/tc≥1.2 is satisfied.

6. The lighting equipment according to claim 1,
wherein the plurality of pillar-shaped or flat plate-shaped heat conductive members have a substantially cylindrical external appearance.

7. The lighting equipment according to claim 1,
wherein a maximum temperature area resulting from a heat generation of the LED light emitting device exists within a central area of the bottom plate.

8. The lighting equipment according to claim 1,
wherein a heat conductivity of the heat sink ranges from 20 W/(m·k) to 400 W/(m·k).

9. The lighting equipment according to claim 1,
wherein a material of the heat sink is a metal, or boron nitride.

10. The lighting equipment according to claim 1,
wherein when assuming that a diagonal maximum length of the LED light emitting device is L_{E}, and a diagonal maximum length of the bottom plate is L_{B}, L_{E}/L_{B} is 0.7 or smaller.

11. The lighting equipment according to claim 1,
wherein the diagonal maximum length L_{B} of the bottom plate is 40 mm or greater.

12. The lighting equipment according to claim 1,
wherein a shape of a cross section of the bottom plate including a central portion thereof is any one selected from a group of shapes including a pentagonal shape, a polygonal shape and a convex curve.

13. The lighting equipment according to claim 1,
wherein the LED light emitting device is a COB type light emitting device.

14. The lighting equipment according to claim 1,
wherein the light collecting member is a reflector or a lens.

15. The lighting equipment according to claim 14,
wherein the reflector has a shape of parabolic rotating body.

16. The lighting equipment according to claim 15,
wherein the LED light emitting device is located in a focal position of the reflector having a shape of parabolic rotating body.

17. The lighting equipment according to claim 15,
wherein when assuming that a maximum diameter of a light emitting portion of the LED light emitting device is W, a light emitting center of the LED light emitting device exists within a range of a spherical body whose radius is 5 W from the focal position of the reflector having a shape of parabolic rotating body.
